(19) United States
(12) Patent Application Publication
(10) Pub. No.: US 2018/0009057 A1
(43) Pub. Date: Jan. 11, 2018

(54) METHOD AND DEVICE FOR RESISTANCE WELDING STEEL SANDWICH SHEETS

(71) Applicants: THYSSENKRUPP STEEL EUROPE AG, Duisburg (DE); THYSSENKRUPP AG, Essen (DE)

(72) Inventor: Azeddine CHERGUI, Dortmund (DE)

(73) Assignees: ThyssenKrupp Steel Europe AG, Duisburg (DE); ThyssenKrupp AG, Essen (DE)

(21) Appl. No.: 15/544,283

(22) PCT Filed: Nov. 13, 2015
(86) PCT No.: PCT/EP2015/076542

§ 371 Date: Jul. 18, 2017

(30) Foreign Application Priority Data
Jan. 21, 2015 (DE) 10 2015 100 849.1

(51) Int. Cl. B23K 11/34; B23K 11/00; B23K 11/11; B23K 11/16

(52) U.S. Cl. CPC B23K 11/34; B23K 11/16; B23K 11/002; B23K 11/115

(57) ABSTRACT

A method of resistance welding a component to a sandwich sheet, which includes a thermoplastic layer disposed between two metallic outer layers, may involve heating a region of the sandwich sheet to be welded such that the thermoplastic layer softens, displacing the thermoplastic layer from the region by pressing the outer layers together, and welding the outer layers to the component by an electrical current flow for welding in a first circuit. The first circuit may include a first power source via a first welding electrode arranged at a side of the sandwich sheet and a second welding electrode arranged at a side of the component. This method is easy to run and achieves short cycle times due at least in part to the region being heated by a current flow for preheating in a second circuit that comprises a second power source and an electrical conductor that is arranged between the first welding electrode and the sandwich sheet.”

The invention relates to a method of resistance welding a sandwich sheet to at least one further component, where the sandwich sheet has two metallic outer layers and a thermoplastic layer arranged between the metallic outer layers, where the region of the sandwich sheet to be welded is heated in such a way that the thermoplastic layer softens and is displaced from the weld region by pressing the outer layers together and the outer layers are welded to the further component by an electrical current flow for welding in a first circuit having a first power source via a first welding electrode arranged on the side of the sandwich sheet and a second welding electrode arranged on the side of the further component. The invention additionally relates to an apparatus for resistance welding of a sandwich sheet having a thermoplastic layer arranged between metallic outer layers to at least one further component, comprising a first welding electrode that can be arranged on the side of the sandwich sheet, comprising a second welding electrode that can be arranged on the side of the further component, comprising means of providing a first circuit having a first power source, said means leading to current flow for welding at least through the first and second welding electrodes, and comprising means of displacing the thermoplastic layer of the sandwich sheet from the region of the sandwich sheet to be welded.

Rising demand for lightweight construction concepts in the motor vehicle sector is attracting interest in the use of sandwich sheets, in order to further increase the weight-saving potential in motor vehicle construction using sandwich sheets. Sandwich sheets have a thermoplastic layer between two thin metallic outer layers. As a result, sandwich sheets can provide various, frequently mutually exclusive properties that open up new potential for weight-saving. For instance, sandwich sheets, because of the polymer layer, have a much lower weight than solid sheets and at the same time provide high strength values. Furthermore, the sandwich sheets are sound-insulating and give high stiffness. However, a drawback of sandwich sheets is that they have an electrically insulating layer which causes problems in relation to the formation of a flawless weld bond in welding methods. Due of the lack of suitability of the sandwich sheets for welding, for example for resistance welding or resistance point welding to other components, especially metallic components, sandwich sheets are therefore frequently adhesive bonded or mechanically joined to one another.

In order nevertheless to enable a weld bond, German published specification DE 10 2011 109 708 A1 discloses a method of joining a sandwich sheet to a further component, in which the intermediate layer is melted in the bonding region and displaced from the bonding region, such that it is subsequently possible to produce a weld bond by establishing an electrical contact between the component and the outer layers of the sandwich sheet. It is proposed that the heating of the joining regions be conducted by means of temperature-controllable electrodes or press elements. The welding electrodes or press elements are provided with heating elements, for example, for the purpose. Because of the necessary modifications to the welding electrode, the construction of the welding electrodes thus becomes relatively complex. Moreover, the speed of heating of the thermoplastic layer is in need of improvement in order that shorter cycle times can be achieved.

US patent specification U.S. Pat. No. 4,650,951 additionally discloses a method of resistance welding of two composite sheets, which uses two welding electrodes that are heated and thus heat and displace the polymer layer between the outer layers, before the actual welding commences. For this purpose, heating elements are arranged around the electrodes. Here too, the speed of heating of the thermoplastic layer is in need of improvement in order to achieve shorter cycle times.

Proceeding from this, it is an object of the present invention to provide a method of resistance welding of sandwich sheets and a corresponding apparatus, which are designed to be easy to run and can additionally achieve short cycle times.

The stated object is achieved, according to a first teaching of the present invention, in a method of the generic type in that the region of the sandwich sheet to be welded is heated by a current flow for preheating in a second circuit, where the second circuit comprises an electrical conductor arranged between the first welding electrode and the sandwich sheet, and a second power source.

The combination of a second power source and an electrical conductor in the second circuit which is arranged between the first welding electrode and the sandwich sheet for heating of the region to be welded can achieve heating of the region to be welded without further modifications merely by activation or deactivation of the second power source which is different than the first power source. For example, there is no need for any extensive modifications to the welding electrode, for example integration of heating elements into the electrode body, nor is there any requirement for application or connection of additional conductors such as current bridges in the sandwich sheet or the second welding electrode. In addition, it is possible to avoid undesirable branch currents, particularly via existing weld bonds in the sandwich sheet. At the same time, efficient heating of the region to be welded is advantageously achieved via the electrical conductor arranged between the first welding electrode and the sandwich sheet, for example by means of an appropriately configured specific electrical resistance of the electrical conductor. The result is therefore provision of a method which enables easy running and can additionally achieve short cycle times.

The further component may, for example, be a solid metallic sheet, for example a steel sheet. In principle, it is alternatively possible that the further component too is a sandwich sheet. It is likewise also possible to provide further components which are welded, for instance an additional metallic component arranged between the sandwich sheet and the further component, especially a metallic component.

The first and/or second power sources may, for example, be DC current or preferably AC current sources. In this case, the dedicated power sources for the first and second circuits may be designed as required and independently of one another.

The first circuit preferably comprises, in particular, the first power source, the first welding electrode, the second welding electrode, first electrical wires connected to the first and second welding electrodes, the sandwich sheet and the further component.

The second circuit preferably comprises, in particular, the second power source, the electrical conductor, and second electrical wires connected to the electrical conductor. Thus, the second circuit preferably does not comprise the sandwich sheet, the further component, the first welding electrode and/or the second welding electrode.

If, in one configuration of the method of the invention, the second power source is activated first, so that there is current flow for preheating in the second circuit, and then the first power source is activated, so that there is current flow for welding in the first circuit, unnecessarily early activation of the first power sources is avoided and the first power source is only activated when required. This avoids unwanted interactions between the circuits and achieves a reliable process outcome in a simple manner.

Preferably, the first power source is activated with or after the deactivation of the second power source. However, it is also conceivable in principle that the first power source is already activated before the deactivation of the second power source. The power sources are controlled, for example, by means of a control means including, for example, a trigger switch. For example, in the case of a trigger switch, an adequate degree of displacement, for example complete displacement, of the thermoplastic layer from the welding region is the triggering event, which generates a switching pulse or a switching edge for the first and/or second power source.

In a further configuration of the method of the invention, the first power source is activated and/or the second power source is deactivated with reference to a measurement representative of the displacement of the thermoplastic layer from the welding region. As a result, it is possible to achieve precise activation and deactivation of the power sources as required. This can also increase the efficiency of the method, since the welding process can commence immediately after adequate displacement of the thermoplastic layer from the welding region. By means of the measurement representative of the displacement of the thermoplastic layer from the welding region, it is possible to continuously conclude the progress of displacement, for example. It is also possible to choose a measurement representative of the displacement of the thermoplastic layer from the welding region from which it is merely possible to conclude individual discrete pieces of information about the progress of the displacement, for instance whether the displacement is already complete or not. For example, the representative measurement can be compared with a reference value.

In a further configuration of the method of the invention, the measurement representative of the displacement of the thermoplastic layer from the welding region is based on an electrical property at least of the sandwich sheet. In this way, contact between the metallic outer layers of the sandwich sheet in the region to be welded can be detected in a simple and reliable manner. For example, the measurement representative of the displacement of the thermoplastic layer from the welding region is measured during the heating of the region to be welded and the pressing-together of the outer layers of the sandwich sheet. For example, an electrical resistance measurement is made, and so the measurement representative of the displacement of the thermoplastic layer from the welding region is an electrical resistance value and comprises the electrical resistance between the outer layers of the sandwich sheet. For this purpose, the electrical resistance can be measured, for example, between the first and second welding electrodes. If the outer layers are in metallic contact, the resistance will in any case be subject to an abrupt drop locally, and so it is possible to conclude that there is adequate displacement of the thermoplastic from the region to be welded. The reference value chosen may be a resistance value which, when measured between the welding electrodes, is undershot in the event of direct contact of the outer layers.

In a further configuration of the method of the invention, the measurement representative of the displacement of the thermoplastic layer from the weld region is based on a position of a welding electrode, preferably the first welding electrode. If the position of the welding electrode is recorded in any case, it is possible to determine in a simple automated manner when there is adequate displacement of the thermoplastic layer from the welding region without needing to conduct a resistance measurement, for example. If, for example, the position of the welding electrode has changed by the thickness of the thermoplastic layer, meaning that the welding electrode has moved by the thickness of the thermoplastic layer, it is possible to conclude that there is adequate displacement of the thermoplastic from the region to be welded. The reference value used here may be the thickness of the thermoplastic layer.

In a particularly preferred configuration of the method of the invention, the electrical conductor arranged between the first welding electrode and the sandwich sheet used is a conductor tape. A conductor tape or contacting tape may, for example, simply be run around the first welding electrode or may envelop it, such that the contact region of the welding electrode that would normally form a contact with the sandwich sheet to be welded, for example the electrode cap, is at least partly covered by the conductor tape.

In a further configuration of the method of the invention, the conductor tape is arranged between the first welding electrode and the sandwich sheet with a tape holder. By means of a tape holder, the conductor tape can be provided in a particularly compact and reliable manner between the first welding electrode and the sandwich sheet. In addition, the tape holder can be designed such that the conductor tape can be moved with respect to the first welding electrode for renewal. As a result, different points on the conductor tape come between the first welding electrode and the sandwich sheet, such that any change in the properties of the conductor tape in the region between the first welding electrode and the sandwich sheet can be counteracted. For example, the tape holder can be mounted on the first welding electrode. If the welding electrodes are provided, for example, by means of welding tongs, the tape holder may, for example, be mounted on or integrated into the welding tongs.

In a further configuration of the method of the invention, the electrical conductor arranged between the first welding electrode and the sandwich sheet forms a direct contact with the first welding electrode and/or the sandwich sheet. In this way, it is possible to achieve efficient heating of the region to be welded and rapid displacement of the thermoplastic layer from the region to be welded.

In a further configuration of the method of the invention, the electrical conductor has a first region having a first specific electrical resistance and a second region having a second specific electrical resistance which is greater than the first specific electrical resistance for heating of the region of the sandwich sheet to be welded. By means of appropriate positioning of the second region, it is possible to achieve efficient and appropriate heating of the region to be welded. For example, the first region consists of copper or a copper alloy. For example, the second region consists of tungsten or a tungsten alloy. While the preheating current is being passed through the copper or copper alloy in the first region with low evolution of heat, the tungsten or tungsten alloy in the second region can evolve heat efficiently. For example, the preheating current can pass from the first to the second region.

As a further example, the conductor, especially the conductor tape, may be in two-layer or multilayer form at least in sections, for example with one layer facing the first welding electrode and one facing the sandwich sheet. For example, the layer facing the sandwich sheet at least partly corresponds to the first region having the first specific electrical resistance. For example, the layer facing the first welding electrode at least partly corresponds to the second region having the second specific electrical resistance.

If, in a further configuration of the method of the invention, the second region is arranged in the contact region of the first welding electrode with the sandwich sheet, the spatial proximity of the second region to the region of the sandwich sheet to be welded can result in efficient heating of the region to be welded, such that it is also possible to achieve shortened cycle times.

If, in a further configuration of the method of the invention, the electrical conductor has a region for insulation, especially for insulation of the first region from the first welding electrode, it is possible to avoid undesirable branch currents, especially by the first welding electrode. The region for insulation may consist, for example, of electrically insulating material. Alternatively or additionally, a region for insulation may be provided on the first welding electrode or on the tape holder.

In a second teaching of the present invention, the object stated at the outset is achieved by providing a second circuit, wherein the second circuit comprises an electrical conductor that can be arranged between the first welding electrode and the sandwich sheet, and a second power source.

As already set out above, the combination of a second power source and an electrical conductor that can be arranged between the first welding electrode and the sheet sandwich in the second circuit for heating of the region to be welded can achieve enablement of heating of the region to be welded in a particularly simple manner by activating or deactivating the second power source. In this case, there is no need either for extensive modifications to the welding electrode nor for provision of additional conductors in the sandwich sheet region or the second welding electrode. At the same time, the electrical conductor arranged between the first welding electrode and the sandwich sheet achieves efficient heating of the region to be welded. The outcome is therefore provision of an apparatus which enables simple running and can additionally achieve short cycle times.

The apparatus may especially be suitable for performance of the process.

In a preferred configuration of the apparatus of the invention, there is provision of a control means which is coupled to the first and second power sources and is configured such that the second power source is activated first, so that there is current flow for preheating in the second circuit, and then the first power source is activated, so that there is current flow for welding in the first circuit. This avoids unnecessarily early activation of the first power source, and the first power source is only activated when required.

In a further configuration of the apparatus of the invention, the control means, for activation of the first power source and/or deactivation of the second power source, is set up with reference to a measurement representative of the displacement of the thermoplastic layer from the weld region. In this way, it is possible to achieve precise activation and deactivation of the power sources as required.

In a further configuration of the apparatus of the invention, the electrical conductor arranged between the first welding electrode and the sandwich sheet is a conductor tape. This can simply run around the first welding electrode or can envelop it, such that the contact region of the welding electrode is at least partly covered by the conductor tape.

With regard to further advantageous configurations of the apparatus of the invention, reference is made to the description of the embodiments of the method and the advantages thereof.

In this case, the description of method steps in preferred embodiments of the method of the invention shall also disclose corresponding means of performing the method steps by preferred embodiments of the apparatus of the invention. The disclosure of means of performing a method step shall likewise disclose the corresponding method step.

Also disclosed is a method of resistance welding a sandwich sheet to at least one further component, where the sandwich sheet has two metallic outer layers and a thermoplastic layer arranged between the metallic outer layers, where the region of the sandwich sheet to be welded is heated in such a way that the thermoplastic layer softens and is displaced from the weld region by pressing the outer layers together and the outer layers are welded to the further component by an electrical current flow for welding in a first circuit having a first power source via a first welding electrode arranged on the side of the sandwich sheet and a second welding electrode arranged on the side of the further component, wherein the region of the sandwich sheet to be welded is heated by a current flow for preheating in a second circuit, where the second circuit comprises an electrical conductor arranged between the first welding electrode and the sandwich sheet.

Additionally disclosed is an apparatus for resistance welding of a sandwich sheet having a thermoplastic layer arranged between metallic outer layers to at least one further component, comprising a first welding electrode that can be arranged on the side of the sandwich sheet and comprising a second welding electrode that can be arranged on the side of the further component, comprising means of providing a first circuit having a first power source, said means leading to a welding current at least from through first and second welding electrodes, and comprising means of displacing the thermoplastic layer of the sandwich sheet from the region of the sandwich sheet to be welded, a second circuit is provided, where the second circuit comprises an electrical conductor that can be arranged between the first welding electrode and the sandwich sheet.

The first and second circuits may have a common power source. For this purpose, the first circuit may, for example, have the first power source, the electrical conductor, the first welding electrode, and second electrical wires connected to the electrical conductor.

Configurations of the method and the apparatus may be as described above. For example, the electrical conductor arranged between the first welding electrode and the sandwich sheet may be a conductor tape. For example, the electrical conductor may have a first region having a first specific electrical resistance and a second region having a second specific electrical resistance which is greater than the first specific electrical resistance for heating of the region of the sandwich sheet to be welded.

The invention is to be elucidated in detail hereinafter with reference to working examples in conjunction with the drawing. The drawing shows, in

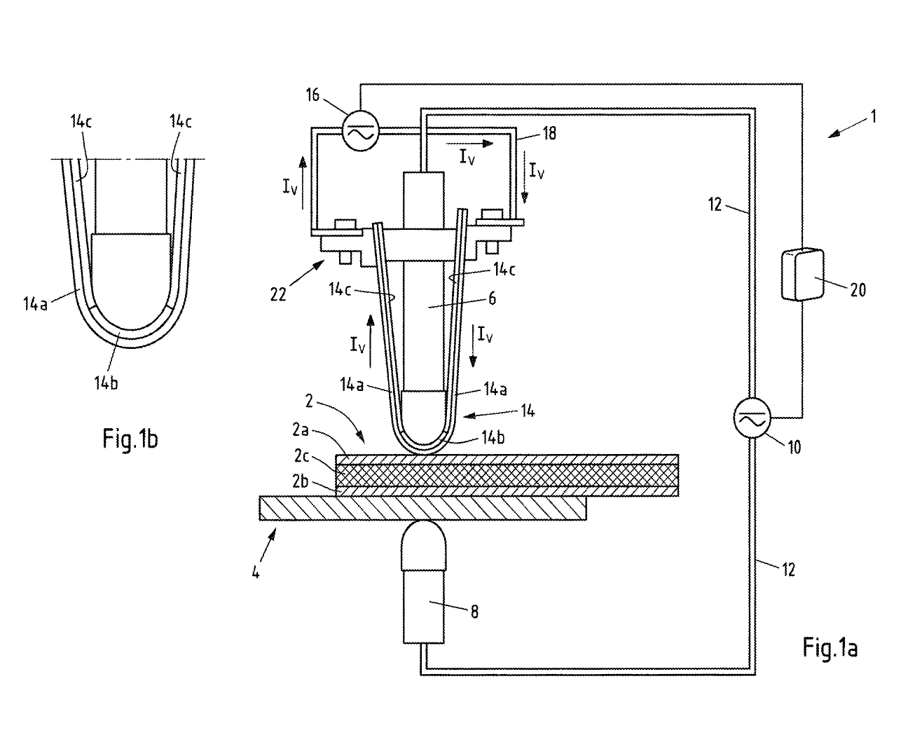

FIGS. 1a,b a schematic diagram of a first working example of an apparatus of the invention for performance of a first working example of a method of the invention during preheating;

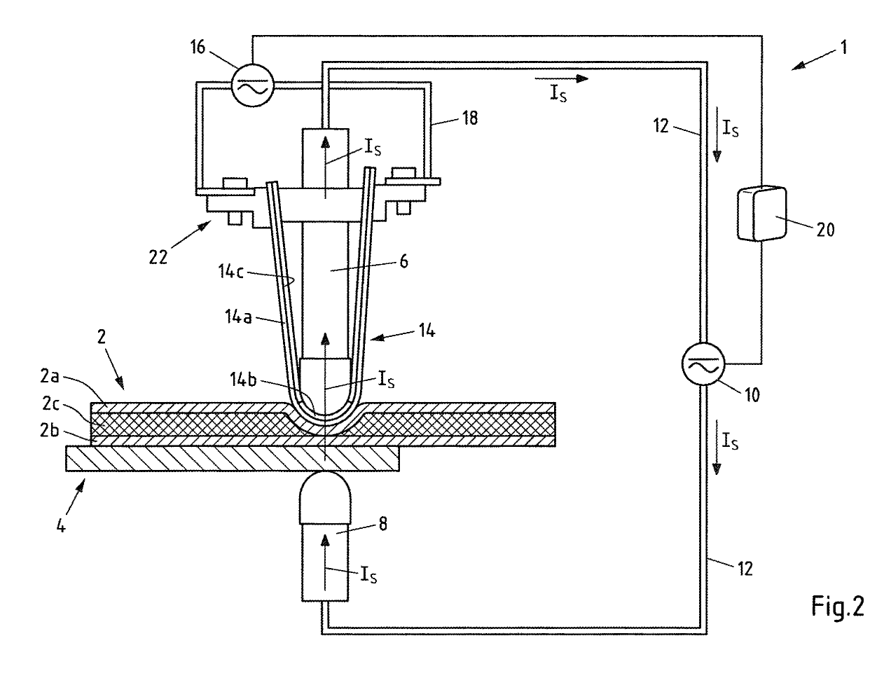

FIG. 2 a schematic diagram of the working example from FIG. 1 during welding;

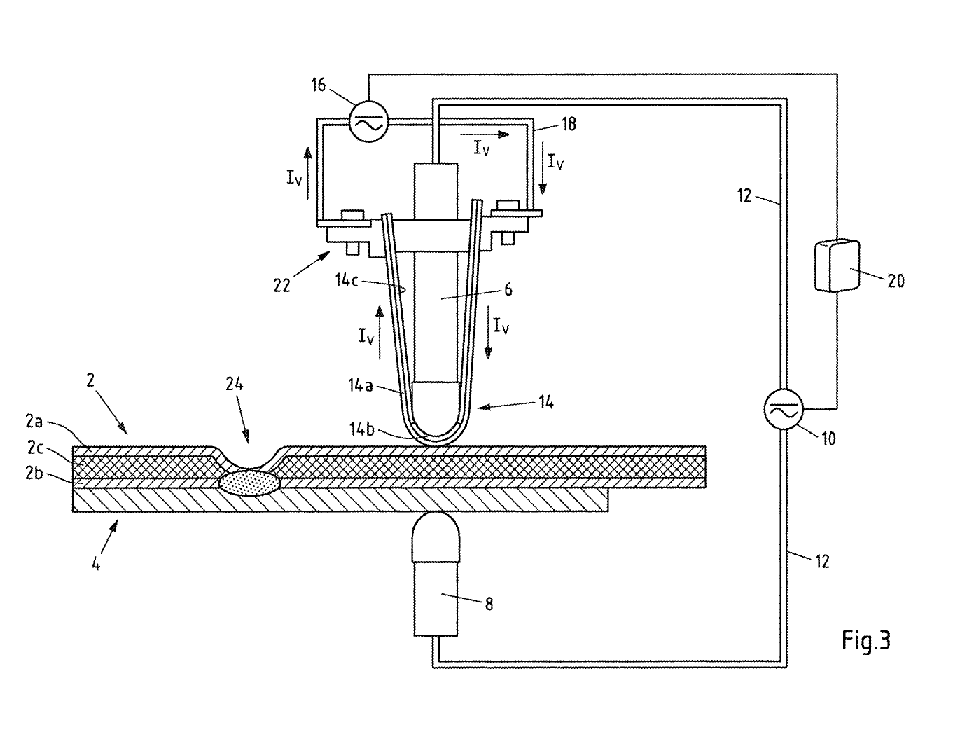

FIG. 3 a schematic diagram of the working example from FIG. 1 during multipoint resistance welding;

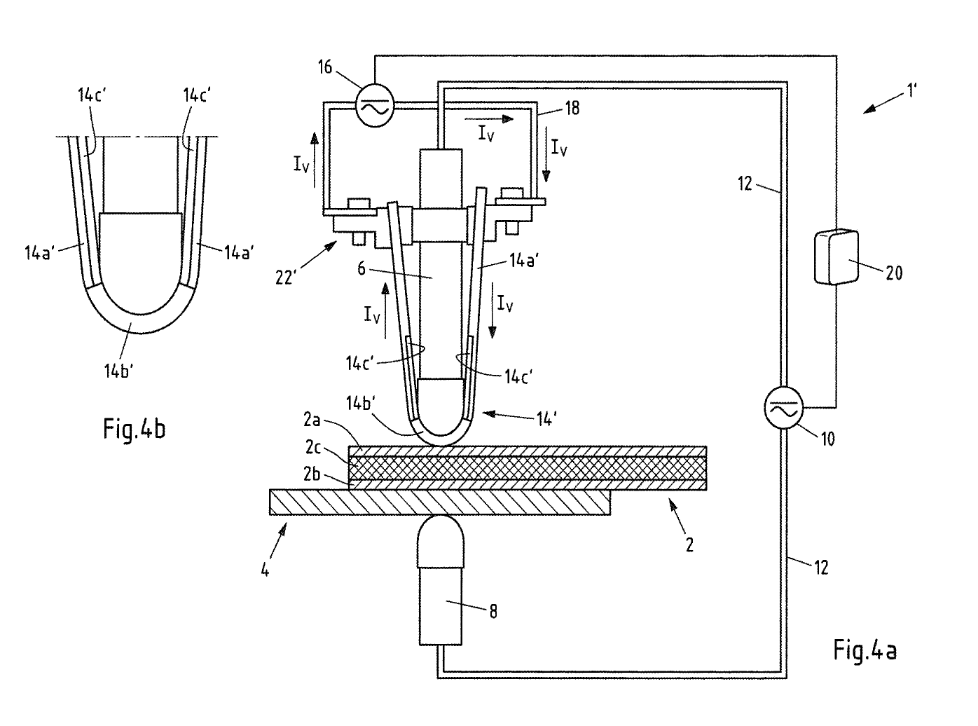

FIGS. 4a,b a schematic diagram of a further working example of an apparatus of the invention for performance of a further working example of a method of the invention during preheating;

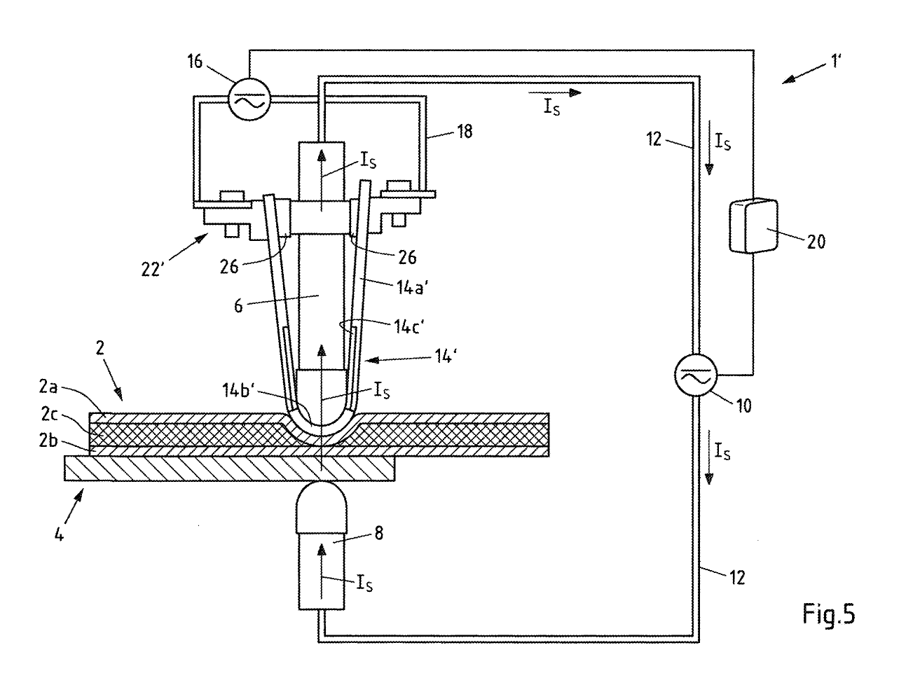

FIG. 5 a schematic diagram of the working example from FIG. 4 during welding and

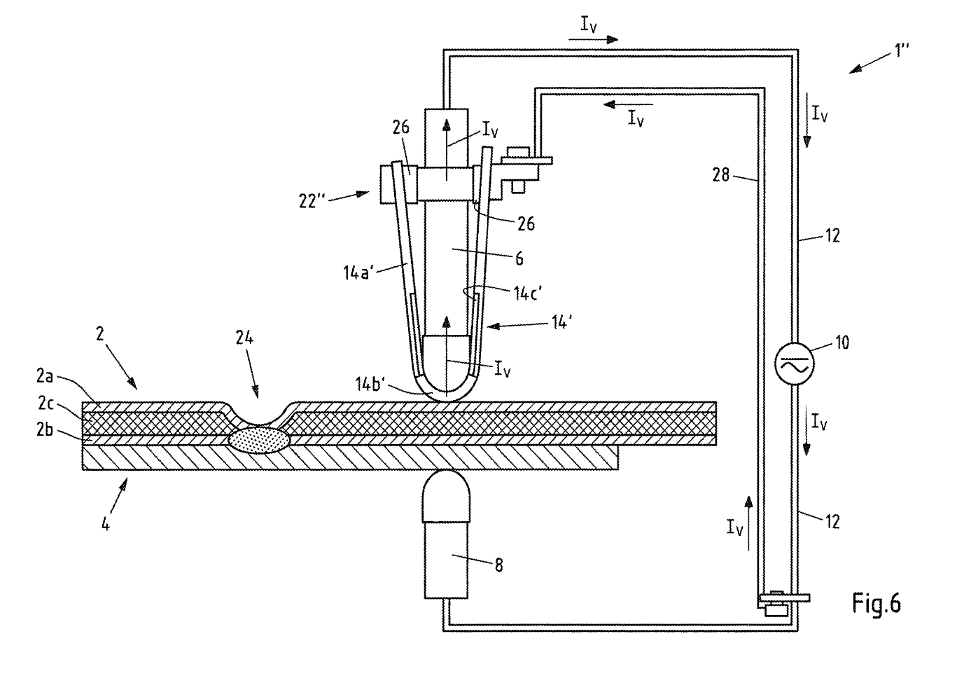

FIG. 6 a schematic diagram of a further apparatus for performance of a further method.

FIG. 1a shows a schematic diagram of a first working example of an inventive apparatus 1 for performance of a first working example of a method of the invention during preheating. The apparatus 1 serves for resistance welding of a sandwich sheet 2 to at least one further component 4, for example a metallic component. The sandwich sheet 2 has a thermoplastic layer 2c arranged between metallic outer layers 2a, 2b. The apparatus has a first welding electrode 6 arranged on the side of the sandwich sheet 2, and a second welding electrode 8 arranged on the side of the further metallic component 3. Additionally provided, by the first power source 10 and the first electrical wires 12, are means of providing a first circuit. As a result, it is possible to conduct a current flow for welding Is through the first and second welding electrodes 6, 8 (shown in FIG. 2).

In addition, the first welding electrode 6 serves as a means of displacing the thermoplastic layer 2c of the sandwich sheet 2 from the region of the sandwich sheet 2 to be welded. It is likewise possible to provide means of applying forces, for instance welding tongs (not shown).

Additionally provided is a second circuit comprising an electrical conductor 14 arranged between the first welding electrode 6 and the sandwich sheet 2, a second power source 16 and second electrical wires 18. The electrical conductor 14 arranged between the first welding electrode 6 and the sandwich sheet 2 takes the form of a conductor tape and is arranged by means of a tape holder 22 between the first welding electrode 6 and the sandwich sheet 2. In this case, the electrical conductor tape 14 forms a direct contact with the first welding electrode 6 and the sandwich sheet 2. The electrical conductor tape 14 has a first region 14a having a first specific electrical resistance and a second region 14b having a second specific electrical resistance for heating of the region of the sandwich sheet 2 to be welded. The first region 14a is made, for example, from copper, and the second region 14b from tungsten. As a result, the second specific electrical resistance is greater than the first specific electrical resistance. Finally, the electrical conductor tape 14 has a region 14c for insulation of the first region 14a with respect to the welding electrode 6.

FIG. 1b shows a modification of the conductor tape 14 in the region of contact formation with the first welding electrode 6.

Since the second region 14b is arranged in the contact region of the first welding electrode 6 with the sandwich sheet 2, the region of the sandwich sheet 2 to be welded can be heated particularly efficiently, so that the thermoplastic layer 2c softens quickly and is displaced from the welding region by pressing the outer layers 2a, 2b together. This is effected by a current flow for preheating I_{V} in the second circuit, which is shown in FIG. 1a by the arrows. The electrical energy is transformed here to heat by the electrical resistance of the second region 14b and the passage resistance between the first region 14a and the second region 14b.

Additionally provided is a control means 20 which comprises a trigger switch and is coupled to the first and second power sources 10, 16. The control means is set up such that the second power source 16 is activated first, so that there is current flow for preheating I_{V} in the second circuit.

The softening and displacement of the thermoplastic layer 2c, so that the outer layers 2a, 2b are in metallic contact, is determined by the consideration of a measurement representative of this. This may, for example, be a drop in the electrical resistance between the welding electrodes 6, 8 or a distance traveled by the first welding electrode 6 that corresponds to the thickness of the thermoplastic layer 2c.

If it is detected by the control means 20 that the thermoplastic layer 2c has been displaced from the welding region (as shown in FIG. 2), the second power source 16 is deactivated and the first power source 10 is activated, such that there is current flow for welding I_{S} in the first circuit.

FIG. 2 shows a schematic diagram of the working example from FIG. 1 during welding. The control means 20 deactivates the second power source 16 and activates the second power source 10. The welding current I_{S}, as shown by the arrows in FIG. 2, flows in the first circuit through the electrical wires 12, the first and second welding electrodes 6, 8, the further component 4 and the sandwich sheet 2. As a result of this, the outer layers 2a, 2b are welded to the further component 4 by the electrical current flow for welding I_{S}.

FIG. 3 shows a schematic diagram of the working example from FIG. 1 during multipoint resistance welding. By contrast with the case shown in FIGS. 1 and 2, there is already a weld bond 24 in FIG. 3. By virtue of a second circuit having been provided with a second power source 16, the electrical connection between the first and second welding electrodes 6, 8 that results from the weld bond 24 does not result in any undesirable branch currents during the preheating. Instead, there is current flow for preheating I_{V} as already shown in FIG. 1.

FIG. 4a shows a schematic diagram of a second working example of an inventive apparatus 1′ for performance of a working example of a method of the invention during preheating. The apparatus 1′ and the method conducted therewith are similar to the apparatus 1 and the method conducted therewith. In this respect, reference is made at first to the description for FIGS. 1 to 3.

The apparatus 1′ again has an electrical conductor 14′ which takes the form of conductor tape and is arranged by means of the tape holder 22′ between the first welding electrode 6 and the sandwich sheet 2 in direct contact therewith. The electrical conductor tape 14′ again has a first region 14a′, a second region 14b′ having a higher specific electrical resistance for heating of the region to be welded, and a region 14c′ for insulation of the first region 14a′ with respect to the welding electrode 6.

FIG. 4b shows an enlargement of the conductor tape 14′ in the region of contact formation with the first welding electrode 6.

By contrast with the apparatus 1, however, the regions of the electrical conductor tape 14′ of the apparatus 1′ are arranged differently. In the contact region of the electrical conductor 14′ with the sandwich sheet 2 is arranged exclusively the second region 14b′ having the higher specific electrical resistance, which is in contact with the first welding electrode 6 and the sandwich sheet 2. This is adjoined on all sides by the first region 14a′. The insulating region 14c′ prevents direct electrical contact between the first region 14a′ and the first welding electrode 6 in the region of the electrode cap of the first welding electrode 6. By contrast with the conductor tape 14, however, the conductor tape 14′ does not have any insulating region 14c′ in the region of the tape holder 22′, since the tape holder 22′ already has a region 26 for insulation of the welding electrode 6 with respect to the electrical conductor tape 14′.

As already described, by virtue of the arrangement of the second region 14b′ in the contact region of the first welding electrode 6 with the sandwich sheet 2, the region of the sandwich sheet 2 to be welded can be heated particularly efficiently, such that the thermoplastic layer 2c softens quickly and is displaced from the weld region by pressing the outer layers 2a, 2b together. This is effected by current flow I_{V} in the second circuit, which is indicated by the arrows in FIG. 4a.

Subsequently, as shown in FIG. 5 by means of the arrows and as already described in connection with FIG. 2, the sandwich sheet 2 can be welded to the further component 4 by means of the current for welding I_{S}.

FIG. 6 shows a schematic diagram of a further apparatus 1″ for performance of a further method. The apparatus 1″ is of similar construction to the apparatus 1′, and the same electrical conductor tape 14′ is used. By contrast with the apparatus 1′ described in FIG. 4, however, the apparatus 1″ does not have a second power source. Instead, the preheating current I_{V} is also provided by the first power source 10. For this purpose, an electrical bridge 28 is provided, which connects the first power source 10 to the conductor tape 14′ via the tape holder 22″, bridging over the second welding electrode 8, the further component 4 and the sandwich sheet 2. Thus, the second circuit for preheating comprises the first power source 10, some of the first electrical wires 12, the first welding electrode 6, the electrical conductor tape 14′ and the electrical bridge 28. The preheating current can then flow as shown by the arrows in FIG. 6.

1.-15. (canceled)

16. A method of resistance welding a component to a sandwich sheet that comprises a thermoplastic layer disposed between two metallic outer layers, the method comprising:
heating a region of the sandwich sheet to be welded such that the thermoplastic layer softens;
displacing the thermoplastic layer in the region to be welded by pressing the two metallic outer layers together; and
welding the two metallic outer layers to the component by an electrical current flowing for welding in a first circuit via a first welding electrode disposed at a side of the sandwich sheet and a second welding electrode disposed at a side of the component, wherein the first circuit comprises a first power source,
wherein the region of the sandwich sheet to be welded is heated by an electrical current flowing for preheating in a second circuit, wherein the second circuit comprises a second power source and an electrical conductor that is disposed between the first welding electrode and the sandwich sheet.

17. The method of resistance welding of claim 16 further comprising:
activating the second power source so that the electrical current is flowing for preheating in the second circuit; and
activating the first power source after the second power source has been activated so that the electrical current is flowing for welding in the first circuit.

18. The method of resistance welding of claim 16 further comprising at least one of activating the first power source or deactivating the second power source based on a measurement representative of displacement of the thermoplastic layer from the region to be welded.

19. The method of resistance welding of claim 18 wherein the measurement representative of displacement of the thermoplastic layer from the region to be welded is based on an electrical property of the sandwich sheet.

20. The method of resistance welding of claim 18 wherein the measurement representative of displacement of the thermoplastic layer from the region to be welded is based on a position of the first or second welding electrodes.

21. The method of resistance welding of claim 16 wherein the electrical conductor disposed between the first welding electrode and the sandwich sheet is a conductor tape.

22. The method of resistance welding of claim 21 wherein the conductor tape is disposed between the first welding electrode and the sandwich sheet with a tape holder.

23. The method of resistance welding of claim 16 wherein the electrical conductor disposed between the first welding electrode and the sandwich sheet is in direct contact with at least one of the first welding electrode or the sandwich sheet.

24. The method of resistance welding of claim 16 wherein the electrical conductor includes a first region having a first electrical resistance and a second region having a second electrical resistance, wherein the second electrical resistance is greater than the first electrical resistance.

25. The method of resistance welding of claim 24 wherein the second region of the electrical conductor is disposed in a contact region of the first welding electrode with the sandwich sheet.

26. The method of resistance welding of claim 24 further comprising insulating the first region from the first welding electrode with a region for insulation of the electrical conductor.

27. An apparatus for resistance welding a component to a sandwich sheet comprising a thermoplastic layer disposed between metallic outer layers, the apparatus comprising:
a first welding electrode that is positionable on a side of the sandwich sheet;
a second welding electrode that is positionable on a side of the component;
a first circuit through which an electrical current for welding can flow, at least through the first and second welding electrodes, wherein the first circuit comprises a first power source;
means for displacing the thermoplastic layer from a region of the sandwich sheet to be welded; and
a second circuit comprising a second power source and an electrical conductor that is positionable between the first welding electrode and the sandwich sheet.

28. The apparatus for resistance welding of claim 27 further comprising control means coupled to the first and second power sources, wherein the control means is configured to activate the second power source first so that there is an electrical current for preheating flowing in the second circuit, wherein the control means is configured to activate the first power source after the second power source has been activated so that the electrical current for welding can flow in the first circuit.

29. The apparatus for resistance welding of claim 28 wherein the control means is configured to receive a measurement representative of displacement of the thermoplastic layer from the region to be welded for purposes of at least one of activating the first power source or deactivating the second power source.

30. The apparatus for resistance welding of claim 29 wherein the measurement is based on an electrical property of the sandwich sheet.

31. The apparatus for resistance welding of claim 29 wherein the measurement is based on a position of the first or second welding electrodes.

32. The apparatus for resistance welding of claim 27 wherein the electrical conductor is a conductor tape.

33. The apparatus for resistance welding of claim 32 wherein the conductor tape is disposed between the first welding electrode and the sandwich sheet with a tape holder.

34. The apparatus for resistance welding of claim 27 wherein the electrical conductor includes a first region having a first electrical resistance and a second region having a second electrical resistance, wherein the second electrical resistance is greater than the first electrical resistance.

35. The apparatus for resistance welding of claim 34 wherein the electrical conductor includes a region for insulation of the first region from the first welding electrode.
